(19) United States
(12) Patent Application Publication
(10) Pub. No.: US 2024/0380287 A1
(43) Pub. Date: Nov. 14, 2024

(54) lithium battery motor and its transportation mode plug

(71) Applicant: Changzhou Yooksmart Innovation Co., Ltd, Changzhou (CN)

(72) Inventors: Qixu LIU, Changzhou (CN); Hongfei NIE, Changzhou (CN); Feng ZHOU, Changzhou (CN); Tao WU, Changzhou (CN); Lixian HUANG, Changzhou (CN)

(73) Assignee: Changzhou Yooksmart Innovation Co., Ltd, Changzhou (CN)

(21) Appl. No.: 18/432,856

(22) Filed: Feb. 5, 2024

(30) Foreign Application Priority Data
May 9, 2023 (CN) 2023210946828

(51) Int. Cl. H02K 11/00; H01M 10/052; H01R 13/443; H01R 13/66

(52) U.S. Cl. CPC H02K 11/0094; H01M 10/052; H01R 13/443; H01R 13/66

(57) ABSTRACT

This utility model relates to a lithium battery motor and its transportation mode plug, and the transportation mode plug comprises a circuit component and a sheath component. The circuit component comprises a plug connector and a circuit board, and one end of the plug connector is fixedly connected to the circuit board. The sheath component is wrapped on the outside of the circuit board and one end of the plug connector. A short circuit is arranged on the circuit board. The micro control unit in the motor of this utility model controls the operation of the motor body by continuously detecting the level of the IO port. A short circuit is arranged on the circuit board to reduce the level of the IO port when the plug is inserted into the motor.

### INCORPORATION BY REFERENCE

This application claims priority to CN Application No. 2023210946828, filed May 9 2023, which is hereby incorporated by reference in its entirety.

### TECHNICAL FIELD

This utility model relates to a lithium battery motor and its transportation mode plug.

### BACKGROUND TECHNOLOGY

The existing intelligent control motors with lithium battery have two defects: 1. They remain in a standby state of high power consumption when they are not in use for a long time. The reason is that the motor needs to be in a state of receiving signals for a long time, and the power consumption in the standby state is still high. Long-term standby state may cause deletion of the lithium battery, the lifespan of the lithium battery will be greatly affected and it may even be impossible to start. 2. During transportation of the product, the motor fails to turn off signal receiving, thus resulting in abnormal start during transportation.

In addition, some manufacturers may add mechanical switches additionally for power outages during transportation. However, due to limited space of the whole motor, the switch has to be placed in a location that is difficult for customers to reach (Dooya tubular lithium battery motor), which is not convenient for use by customers.

### Content of the Utility Model

This utility model aims to provide a lithium battery motor and its transportation mode plug to solve the technical problems mentioned in the above background technology.

The technical solution to serving the purpose of this utility model is the transportation mode plug of a lithium battery motor, which comprises a circuit component and a sheath component; the circuit component comprises a plug connector and a circuit board, and one end of the plug connector is fixedly connected to the circuit board; the sheath component is wrapped on the outside of the circuit board and one end of the plug connector; a short circuit is arranged on the circuit board. Additionally, we have:

One end of the two output pins of the short circuit connected.

The material of the sheath component is insulation material.

A boss is arranged on the sheath component; the boss is located on the outside of one end of the plug connector.

The whole sheath component is a circular arc.

A plug buckle position is set on the sheath component.

A lithium battery motor comprises a motor body, a charging port, a micro control unit, a lithium battery and a transportation mode plug of the lithium battery motor; the charging port, the micro control unit, and the lithium battery are electrically connected; the charging port matches the plug connector; the micro control unit controls the operation of the motor body by detecting the level of IO.

The above technical solution is adopted, and this utility model has the following beneficial effects:

(1) The micro control unit in the motor of this utility model controls the operation of the motor body by continuously detecting the level of the IO port. A short circuit is arranged on the circuit board to reduce the level of the IO port when the plug is inserted into the motor, so as to cut off the peripheral circuit of the system, realize transportation mode, avoid battery depletion caused by long-term standby state, and avoid abnormal startup during transportation. Additional devices are not required, and the overall appearance is intact.

(2) The sheath component of this utility model is made of insulation material, which is easy for processing and injection molding and has good electrical insulation property, and the service life of the parts is long.

(3) A boss is arranged on the sheath component of this utility model. It can better match the holes of the corresponding charging ports on the motor shell, in order to prevent foreign objects from entering the charging ports, and effectively protect the motor during transportation and long-term standby state.

(4) A plug buckle position is set on the sheath component of this utility model, and it can provide a force bearing point to make it easy for customers to pull out the plug.

### DESCRIPTION OF DRAWINGS

In order to make the content of the utility model more clear, this utility model is further described below according to specific embodiment and based on the drawings, wherein

FIG. 1 is a structural schematic diagram of the plug of the utility model.

FIG. 2 is a side view of the circuit component of this utility model.

FIG. 3 is a structural schematic diagram of the circuit board of this utility model.

FIG. 4 is a structural schematic diagram of the lithium battery motor of this utility model.

FIG. 5 is a partial enlarged view of part A in FIG. 4 of this utility model.

FIG. 6 is a schematic diagram of the internal structure of the lithium battery motor of this utility model.

FIG. 7 is a structural schematic diagram of another sheath component of this utility model.

The numbers in the drawing are: 1. Circuit component; 1-1. Plug connector; 1-2. Circuit board; 1-2-1. Short circuit; 2. Sheath component; 2-1. Boss; 2-2. Plug buckle position; 3. Motor body; 3-1. Charging port; 3-2. Micro control unit;

### SPECIFIC EMBODIMENT

For better understanding of the above technical solution, the above technical solution is detailed below based on the drawings and specific embodiment.

To clarify the purpose, technical solution, and advantages of the embodiment of this utility model, the technical solution in the embodiment of the utility model will be clearly and completely described below based on the drawings in the embodiment of the utility model. Obviously, the described embodiment is only part of the utility model, but not all of them. The components of the embodiment of this utility model described and shown in the drawing usually can be arranged and designed through various configurations.

Therefore, the following detailed description of the embodiment of the utility model provided in the drawings is not intended to limit the scope of the present utility model requiring protection, but only to indicate the selected embodiment of the present utility model. Based on the embodiment of the utility model, all other embodiments obtained by ordinary technicians in the art without making creative labor shall fall within the scope of protection of the utility model.

It should be noted that similar numbers and letters represent similar terms in the following figures. Therefore, once an item is defined in one figure, it does not need to be further defined or interpreted in subsequent figures.

In the description of the embodiment of this utility model, it should be understood that the orientation or position relationship indicated by the terms “center”, “up”, “down”, “left”, “right”, “vertical”, “horizontal”, “inside”, “outside”, etc. is based on the orientation or position relationship shown in the figures, or the orientation or position relationship when the product of the utility model is commonly placed during use, or the orientation or position relationship commonly understood by technical personnel in this field, only for the convenience of describing and simplifying the description of the utility model, rather than indicating or implying that the equipment or component referred to must have a specific orientation, or be constructed and operated in a specific orientation. Therefore, it cannot be understood as a limitation on the utility model.

In the description of the embodiment of this utility model, it should also be noted that, unless otherwise specified and limited, the terms “set”, “install”, “link”, and “connect” shall be broadly understood. For example, it can be fixed connection, detachable connections, or integrated connections; or it can be direct connection or indirect connection through an intermediate medium, or it can be an internal connection between two components. For ordinary technical personnel in this field, the specific meanings of the above terms in this utility model can be understood according to specific circumstances. The utility model is further described in detail based on the drawings. The following embodiment is used only to clearly describe the technical solution of the utility model, and cannot be used to limit the protection scope of the utility model.

### Embodiment 1

As shown in FIG. 1, a transportation mode plug of the lithium battery motor comprises the circuit component 1 and the sheath component 2.

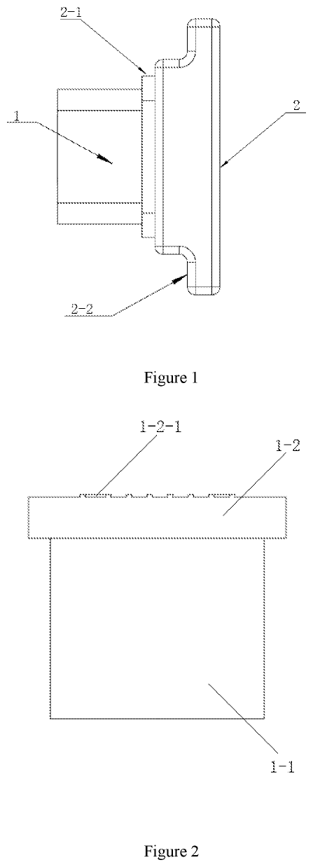

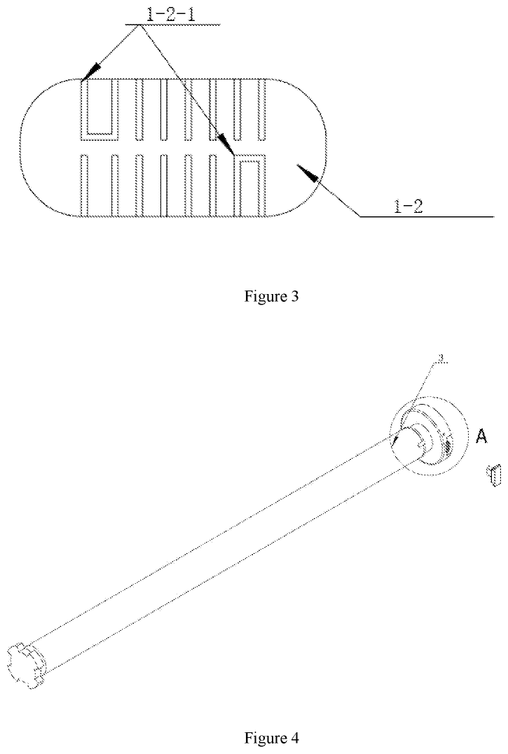

As shown in FIGS. 1-3, the circuit component 1 comprises the plug connector 1-1 and the circuit board 1-2, and the plug connector 1-1 and the circuit board 1-2 are welded together. The TYPEC connector circuit is selected for the circuit on circuit board 1-2. The traditional TYPEC connector has a total of 24 A1-A12 and B1-B12 pins, among which A8 and B8 are SBU interfaces and A12 and B12 are grounded. In this embodiment, A8 and A12 are short-circuited, and B8 and B12 are short-circuited to form a short circuit 1-2-1.

The sheath component 2 is wrapped on the outside of the circuit board 1-2 and one end of the plug connector 1-1. The sheath component 2 is made of insulation material, for example, one type of PP, EVA, TPU, TPV, TPE and TPR. It is easy for processing and injection molding and has good electrical insulation property, and the service life of the parts is long.

The transportation mode plug in this embodiment matches the charging port 3-1, and foreign objects may enter the charging port 3-1 during use, hence affecting normal operation. Therefore, boss 2-1 is arranged on the sheath component 2. It can fully cover the charging port 3-1, tightly connecting the circuit component 1 and the charging port 3-1, and effectively protecting the motor during transportation and long-term standby state.

The plug buckle position 2-2 is set on the sheath component 2, and it can provide a force bearing point to make it easy for customers to pull out the plug.

The transportation mode plug of this embodiment does not require additional devices during use, and the overall appearance is intact when it is used in conjunction with the motor.

### Embodiment 2

As shown in FIG. 4, a lithium battery motor in this embodiment comprises the motor body 3, the charging port 3-1, the micro control unit 3-2, the lithium battery, and the transportation mode plug of the lithium battery motor.

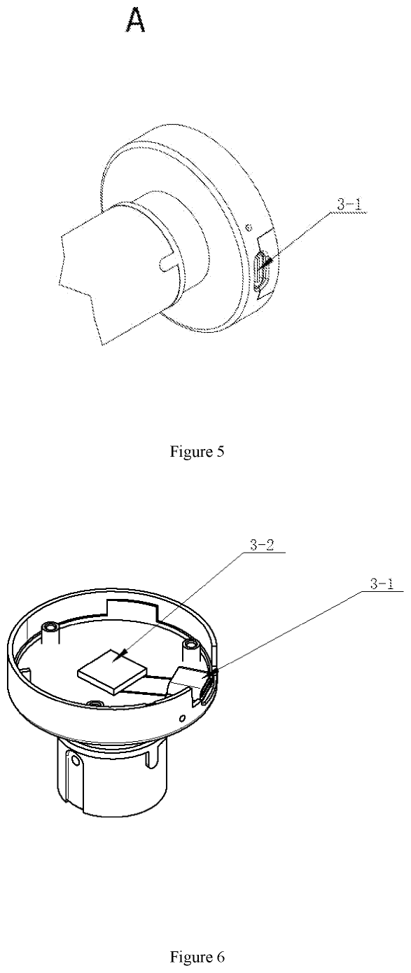

As shown in FIG. 4-6, the lithium battery supplies power to the entire motor. In this embodiment, the charging port 3-1 adopted is the TYPEC charging port. When the level of the lithium battery decreases, the lithium battery can be charged through the charging port 3-1 to ensure normal operation of the motor. The micro control unit 3-2 has two IO ports, one of which is electrically connected to the A8 pin of charging port 3-1, and the other is connected to the B8 pin of the charging port 3-1. When there is no external device intervention, the micro control unit 3-2 always pulls up the level of the IO port.

The micro control unit 3-2 continuously detects the levels of two IO ports. When the micro control unit 3-2 detects that the IO port is at high level, the lithium battery motor remains in normal working state. When the transportation mode plug is inserted into the charging port 3-1, the short circuit 1-2-1 communicates with the micro control unit 3-2, and the micro control unit 3-2 detects that the level of the IO port is pulled down. At this time, the system actively cuts off the unnecessary circuit power supply of the peripheral to achieve transportation mode and avoid battery depletion caused by long-term standby state. When the micro control unit 3-2 detects that the level of the IO port is pulled up again, the system actively initializes and completes the hard power-off function to avoid abnormal start during transportation.

### Embodiment 3

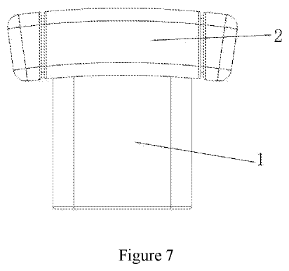

As shown in FIG. 7, compared with the embodiment 1, the whole sheath component 2 is a circular arc. When the plug is used with the lithium battery motor, the outer side of the sheath component 2 fits with the outer wall of the lithium battery motor, and the overall appearance is intact and beautiful.

The above specific embodiment provides further description of the purpose, technical solution, and beneficial effects of the utility model. It should be understood that the above description is only for the specific embodiment of this utility model and should not be used to limit this utility model. Any modifications, equivalent replacements, improvements, etc. made within the spirit and principle of this utility model should be included in the scope of protection of this utility model.

1. The transportation mode plug of a lithium battery motor is characterized in that it comprises a circuit component (1) and a sheath component (2); the circuit component (1) comprises a plug connector (1-1) and a circuit board (1-2), and one end of the plug connector (1-1) is fixedly connected to the circuit board (1-2); the sheath component (2) is wrapped on the outside of the circuit board (1-2) and one end of the plug connector (1-1); a short circuit (1-2-1) is arranged on the circuit board (1-2).

2. The transportation mode plug of the lithium battery motor, according to claim 1, is characterized in that one end of the two output pins of the short circuit (1-2-1) is connected.

3. The transportation mode plug of the lithium battery motor, according to claim 1, is characterized in that the material of the sheath component (2) is insulation material.

4. The transportation mode plug of the lithium battery motor, according to claim 1, is characterized in that a boss (2-1) is arranged on the sheath assembly (2); the boss (2-1) is located on the outside of one end of the plug connector (1-1).

5. The transportation mode plug of the lithium battery motor, according to claim 1, is characterized in that the whole sheath component (2) is a circular arc.

6. The transportation mode plug of the lithium battery motor, according to claim 1, is characterized in that a plug buckle position (2-2) is set on the sheath component (2).

7. A lithium battery motor is characterized in that it comprises: a motor body (3), a charging port (3-1), a micro control unit (3-2), a lithium battery and a transportation mode plug of the lithium battery motor according to claim 1; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.

8. A lithium battery motor is characterized in that it comprises: a motor body (3), a charging port (3-1), a micro control unit (3-2), a lithium battery and a transportation mode plug of the lithium battery motor according to claim 2; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.

9. A lithium battery motor is characterized in that it comprises: a motor body (3), a charging port (3-1), a micro control unit (3-2), a lithium battery and a transportation mode plug of the lithium battery motor according to claim 3; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.

10. A lithium battery motor is characterized in that it comprises: a motor body (3), a charging port (3-1), a micro control unit (3-2), a lithium battery and a transportation mode plug of the lithium battery motor according to claim 4; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.

11. A lithium battery motor is characterized in that it comprises: a motor body (3), a charging port (3-1), a micro control unit (3-2), a lithium battery and a transportation mode plug of the lithium battery motor according to claim 5; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.

12. A lithium battery motor is characterized in that it comprises: a motor body (3), a charging port (3-1), a micro control unit (3-2), a lithium battery and a transportation mode plug of the lithium battery motor according to claim 6; the charging port (3-1), the micro control unit (3-2), and the lithium battery are electrically connected; the charging port (3-1) matches the plug connector (1-1); the micro control unit (3-2) controls the operation of the motor body (3) by detecting the level of IO.
